(19) United States
(12) Patent Application Publication
(10) Pub. No.: US 2007/0277385 A1
(43) Pub. Date: Dec. 6, 2007

(54) Tiltmeter means

(75) Inventors: David Bullock, Grants Pass, OR (US); Gary Holzhausen, Salinas, CA (US); Jeffery Crook, Santa Cruz, CA (US)

Correspondence Address: John S. Reid, 1926 S. Valleyview Lane, Spokane, WA, 99212-0157, US

(73) Assignee: Applied Geomechanics Inc.

(21) Appl. No.: 11/443,678

(22) Filed: May 31, 2006

(51) Int. Cl. G01C 9/06

(52) U.S. Cl. 33/366.11

(57) ABSTRACT

In accordance with one embodiment of the present disclosure, a tiltmeter includes a first elongate element having first and second ends, and a second elongate element having a first end supported by the first end of the first element, and a second end supported by the second end of the first element. The tiltmeter also includes sensing apparatus supported by the second element.

### BACKGROUND

Tiltmeters of the type known to those of ordinary skill in the art are typically employed to detect various geotectonic activities, such as small movements of portions of the earth's strata relative to other portions. Conventional tiltmeters include sensing apparatus enclosed and/or sealed in a protective housing or casing. In operation, a typical tiltmeter is placed underground, such as by burying in the earth and/or lowering into a borehole.

Once placed underground, the tiltmeter usually remains there for a given period of time. During this given period of time, the tiltmeter can be subjected to tilt or rotation caused by movement of the surrounding earth. The sensing apparatus of the tiltmeter can detect and/or measure this tilt, or rotational movement. The sensing apparatus can typically record and/or transmit data indicative of the detected tilt and/or rotational movement. This data can provide a useful basis for analysis of subsurface earth behavior and activity.

It is often desirable for the sensing apparatus of a tiltmeter to detect very minute tilt or rotational movement while in use. Conventional tiltmeter configurations can be problematic in this regard because they often provide less than desirable stability in supporting the sensing apparatus.

### DESCRIPTION OF THE DRAWINGS

FIG. 1 is an isometric view in which a tiltmeter is depicted in accordance with one embodiment of the present disclosure.

FIG. 2 is an exploded isometric view in which several basic components of the tiltmeter of FIG. 1 are depicted.

FIG. 3 is a side elevation sectional view of the tiltmeter as depicted in FIG. 2.

FIG. 4 is another isometric view of the tiltmeter as depicted in FIG. 1, except that the first element is omitted.

### DETAILED DESCRIPTION

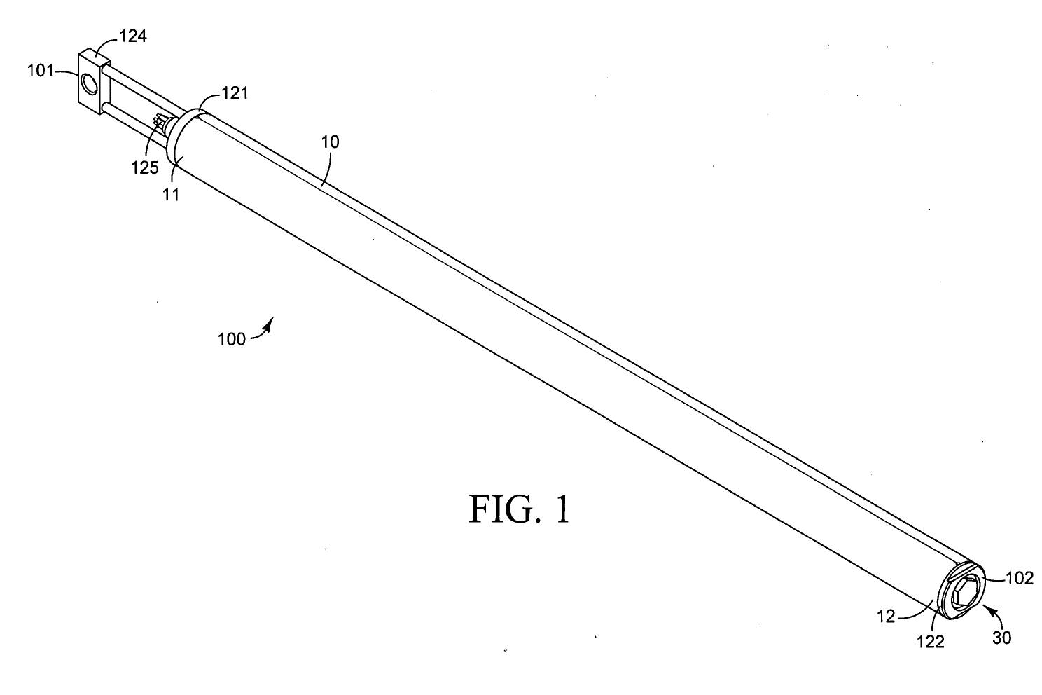

With reference to the drawings, FIG. 1 is an isometric view in which a tiltmeter 100 is depicted in accordance with one embodiment of the present disclosure. The tiltmeter 100 is configured to placed underground by burying in the earth or by lowering into a borehole or the like, as is described in greater detail below. The tiltmeter 100 can be substantially elongate, and can have a first end 101 and a second end 102. The first end 101 of the tiltmeter 100 is opposite and distal from the second end 102. The first end 101 of the tiltmeter 100 can be an upper end, while the second end 102 can be a lower end.

The tiltmeter 100 can include a first elongate element 10. The first element 10 can have a first end 11 and a second end 12, wherein the first end can be opposite and distal from the second end. The tiltmeter 100 can include a first end cap 121 and a second end cap 122. The first end cap 121 can be an upper end cap, and the second end cap 122 can be a lower end cap. The first element 10 can have any of a number of specific forms, including that of a round tube, although other respective forms and/or shapes of the first element are contemplated in accordance with alternative embodiments of the tiltmeter 100.

The tiltmeter 100 can also include a hoisting attachment 124, which can be employed to attach the tiltmeter 100 to a hoist cable, or the like, and/or which can be used as a handle or the like. The tiltmeter 100 can include a connector 125 that can be employed to connect a data signal cable or the like to the tiltmeter for data input/output, or other communications, between the tiltmeter 100 and other devices (not shown). The connector 125 can be supported on the first end cap 121. The tiltmeter 100 can further include a stressing device 30, which is described in greater detail below.

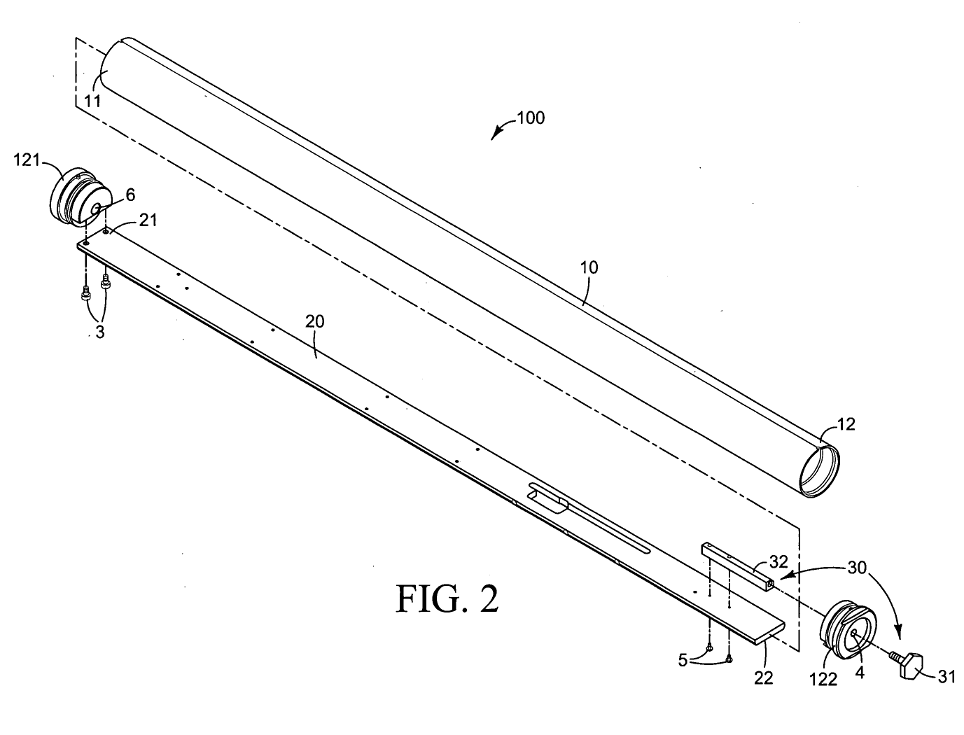

Moving to FIG. 2, which is an exploded view, several basic components of the tiltmeter 100 are depicted in accordance with one embodiment of the present disclosure. That is, several components of the tiltmeter 100, which are discussed below, have been omitted from FIG. 2 for clarity. Along with the first element 10, the first end cap 121, and the second end cap 122, the tiltmeter 100 can include a second elongate element 20. The second element 20 can have a first end 21 and a second end 22.

The first end 21 is opposite and distal from the second end 22. The second element 20 can be substantially in the form of a flat plate or bar, although other respective forms and/or shapes of the first element and of the second element are contemplated in accordance with alternative embodiments of the tiltmeter 100.

For example, although not specifically depicted, alternative forms of the second element 20 can include, but are not limited to, a channel, a beam, a tube and the like. Moreover, although the second element 20 is specifically depicted in the accompanying figures as being a single, unitary member, it is understood that the second element can be made up of two or more members connected together by way of known connection means such as, but not limited to, welding, fastening, threading, and the like.

As is further depicted in FIG. 2, the stressing device 30 can be substantially in the form of, and/or can include, one or more threaded members such as a first threaded member 31 and/or a second threaded member 32. One or more of the threaded members 31, 32 can be externally threaded and/or internally threaded. For example, the first threaded member 31 can be externally threaded while the second threaded member 32 can be internally threaded, as is depicted in the accompanying figures. Moreover, the first threaded member 31 can be configured to threadingly engage the second threaded member 32.

With continued reference to FIG. 2, the first end 21 of the second element 20 can be supported by the first end cap 121. For example, the first end 21 of the second element 20 can be fastened to the first end cap 121 by way of respective fasteners 3. Likewise, the second end 22 of the second element 20 can be supported by the second end cap 122. For example, the second end 22 of the second element 20 can be fastened to the second threaded member 32 by way of respective fasteners 5. The first threaded member 31 can pass through the second end cap 122 by way of an opening 4 defined by the second end cap, and can thus threadingly engage the second threaded member 32.

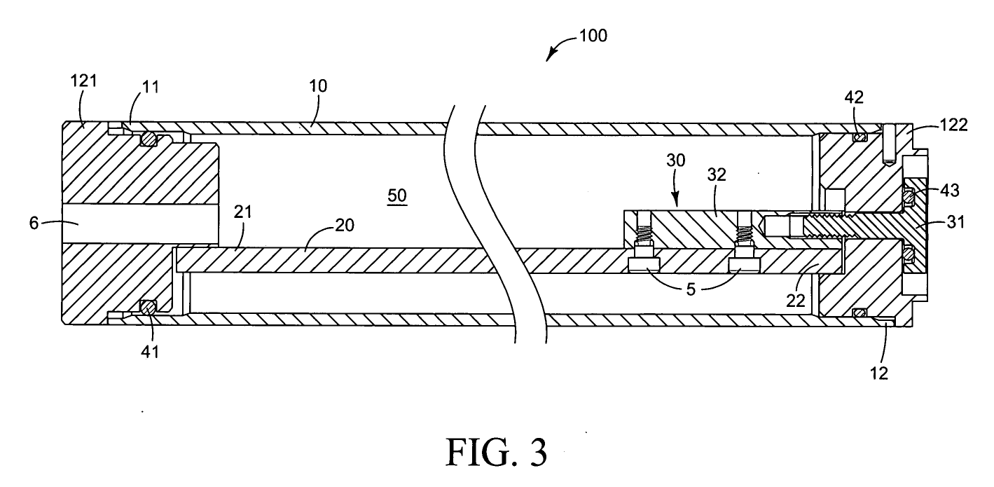

Turning now to FIG. 3, which is a side sectional view, the components discussed above with respect to the exploded view of FIG. 2 are depicted as being fully assembled. As is seen from a study of FIG. 3, the second element 20 can be housed, encased, and/or supported within the first element 10. The first end 21 of the second element 20 can be supported by the first end 11 of the first element 10. Likewise, the second end 22 of the second element 20 can be supported by the second end 12 of the first element 10.

With continued reference to FIG. 3, it is seen that the first end cap 121 can be substantially sealed against the first member 10 by way of a first seal 41. Likewise, the second end cap 122 can be substantially sealed against the first member 10 by way of a second seal 42. Similarly, the first threaded member 31 can be sealed against the second end cap 122 by way of a third seal 43. Each of the first seal 41, second seal 42, and/or third seal 43 can be substantially in the form of an o-ring as depicted, although it is understood that other sealing means known to those of ordinary skill in the art can be employed.

The connector 125 (not shown, but discussed above with respect to FIG. 1) can be sealed in an opening 6 defined by the first end cap 121 by way of any of a number of sealing means known to those of ordinary skill in the art. In this manner, a substantially sealed and substantially fully enclosed space 50 can be formed within the first element 10.

As is mentioned above, the tiltmeter 100 can include the stressing device 30, wherein the stressing device can be operatively disposed between the first element 10 and the second element 20. The stressing device 30 can be employed to induce a given substantially longitudinal force within the second element 20, whereby a substantially equal and opposite substantially longitudinal resultant force can be induced within the first element 10.

For example, inasmuch as the first threaded member 31 is threadingly engaged with the second threaded member 32, it is understood that rotation of the first threaded member relative to the second threaded member can cause the first threaded member to be threaded further into the second threaded member. Thus, the stressing device 30 can cause the second end 22 of the second element 20 to be pulled away from the first end 21 of the second element. That is, by way of operation of the stressing device 30, the second element 20 can be slightly stretched, or strained in tension, to thus induce a given tensile stress within the second element.

It is understood that other forms and/or configurations of the stressing device 30 are contemplated in accordance with various alternative embodiments of the present disclosure. Moreover, it is understood that slight modifications to the stressing device 30 as depicted in the accompanying figures can enable the stressing device to induce a given compressive stress within the second element 20, rather than a tensile stress.

Specifically, for example, the second end cap 122 and/or first threaded member 31 can be modified or changed from the configuration specifically depicted such that the first threaded member is free to rotate relative to the second end cap, but wherein the first threaded member is constrained or held such that axial or longitudinal movement relative to the second end cap is prevented.

With such an exemplary modification to the stressing device 30 and/or to the second end cap 122, as is described above, the stressing device can be operated to induce a compressive stress within the second element 20. For example, with such a modification described above, the first threaded member 31 can be rotated so that the second end 22 of the second element 20 is forced toward the first end 21 of the second element. Such forcing of the first end 21 and second end 22 of the second element 20 toward each other can induce compressive stress within the second element.

Inasmuch as the ends 21, 22 of the second element 20 can be supported by the respective ends 11, 12 of the first element 10, any force that is induced in the second member by the stressing device 30 can result in a substantially equal and opposite force being induced in the first element. For example, with continued reference to FIG. 3, if the stressing device 30 is operated to induce a substantially longitudinal tensile stress in the second element 20 as described above, then a substantially longitudinal compressive stress can be induced in the first element 10 as a result, in accordance with one embodiment of the tiltmeter 100. Alternatively, if the stressing device 30 is configured and operated to induce a substantially longitudinal compressive stress in the second element 20, then a substantially longitudinal tensile stress can be induced in the first element 10 as a result, in accordance with another embodiment of the tiltmeter 100.

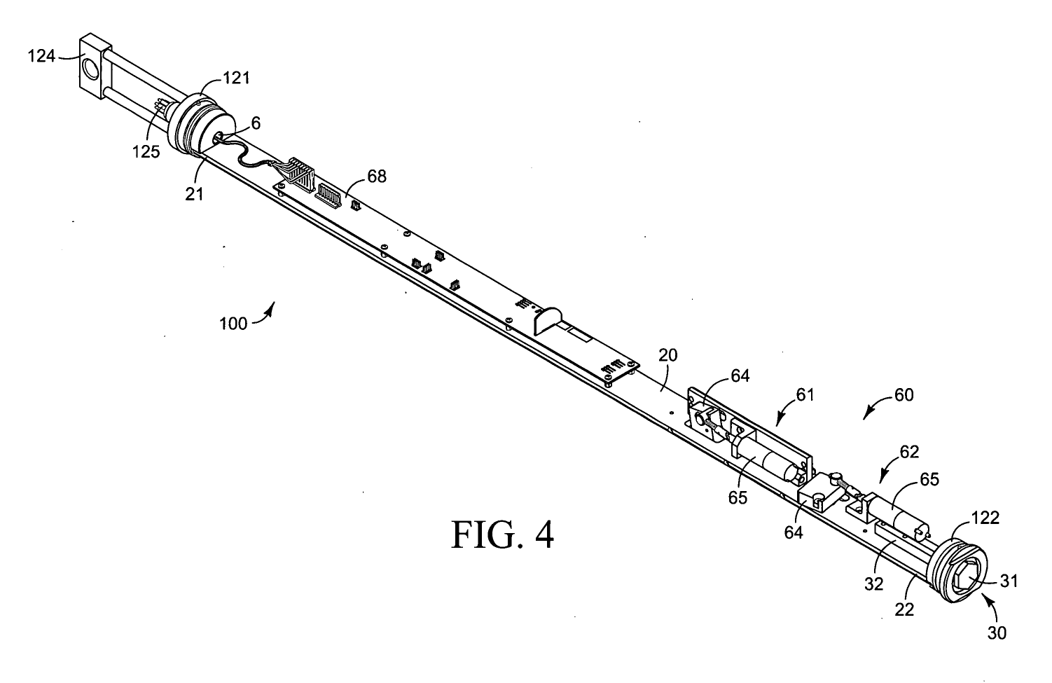

Turning now to FIG. 4, which is an isometric view, a substantially complete and assembled tiltmeter 100 is depicted, with the first element 10 (shown in FIGS. 1 through 3) being omitted for clarity. That is, it is understood that the depiction of the tiltmeter 100 in FIG. 4 is substantially the same as the depiction of the tiltmeter in FIG. 1, except that the first element 10 is not shown in FIG. 4.

With continued reference to FIG. 4, and as is already described above, the first end 21 of the second element 20 can be supported by the first end cap 121, while the second end 22 of the second element can be supported by the second end cap 122. Moreover, the stressing device 30 can be operatively disposed between the second end 22 of the second element 20 and the second end cap 122.

The tiltmeter 100 can further include sensing apparatus 60. One or more components of the sensing apparatus 60 can be supported by the second element 20. In accordance with at least one embodiment of the present disclosure, the sensing apparatus 60 can include one or more sensors 64. The sensor 64 can be of a type known to those of ordinary skill in the art, and can be configured to detect relatively small amounts of tilt or rotational movement. If the tiltmeter 100 includes more than one sensor 64, then each of the sensors can be configured to detect tilt and/or rotational movement in a respective exclusively associated axis or dimension.

The tiltmeter 100 can include a peripheral system 68. The peripheral system 68 can be supported by the second element 20. The peripheral system 68 can include any of a number of components (not referenced), such as electronic components and/or digital components and the like, known to those of ordinary skill in the art, including but not limited to a microprocessor and/or a digital memory.

The peripheral system 68 can be configured to perform any of a number of tasks with regard to the operation of the tiltmeter 100. For example, the peripheral system 68 can be configured to facilitate signal communications to and/or from the tiltmeter 100, wherein such signal communications can include data output and/or command input and the like. The peripheral system 68 can be configured to support the operation and/or function of the sensing apparatus 60, as is described in greater detail below.

The peripheral system 68 can be configured to record, store, or otherwise compile data, and/or to transmit such data, that is detected and/or otherwise generated by the sensing apparatus 60. Accordingly, the peripheral system 68 can be communicatively linked with the sensing apparatus 60 via signal communication means known to those of ordinary skill in the art. The peripheral system 68 can likewise be communicatively linked with the connector 125.

The sensing apparatus 60 can include one or more leveling actuation devices 65. Each leveling actuation device 65 can be exclusively associated with a respective sensor 64. The leveling actuation device 65 can be configured to provide motive force and/or positioning guidance for leveling, or “zeroing in,” the associated sensor 64. The leveling actuation device 65 can include, and/or can be substantially in the form of, an actuator, a linkage, a guide, and the like.

Leveling or “zeroing in” procedures can be performed on each sensor 64 by way of the leveling actuation device 65 and/or other components as is further described below. Leveling of the sensor 64 can be performed, for example, after the tiltmeter 100 is placed underground. For example, the tiltmeter 100 can be lowered into a position within a borehole (not shown) that is not substantially vertical.

In accordance with at least one embodiment of the present disclosure, each sensor 64 can be rotatably supported on the second element 20. Each sensor 64 can be operatively connected to the associated leveling actuation device 65 in a manner wherein the leveling actuation device can selectively rotate, tilt, or otherwise change the orientation of, the associated sensor 65 relative to the second element 20 after the tiltmeter has been placed underground.

Thus, the sensing apparatus 60 can include a first sensor assembly 61 that includes a sensor 64, and which can also include an associated leveling actuation device 65. The sensing apparatus 60 can also include a second sensor assembly 62 that includes a sensor 64, and which can also include an associated leveling actuation device 65.

In accordance with at least one embodiment of the present disclosure, the first sensor assembly 61 can be configured to detect tilt or rotational movement about a first axis or in a first dimension, while the second sensor assembly 62 can be configured to detect tilt or rotational movement about a second axis or in a second dimension.

For example, in consideration of a conventional, standard x,y,z coordinate system, where the z-axis is vertically aligned, one of the sensors 64 can be configured to detect tilt and/or rotational movement about the x-axis, while another of the sensors can be configured to detect tilt and/or rotational movement about the y-axis.

Similarly, one of the leveling actuation devices 65 can be configured to selectively adjust the angular orientation, or tilt, of the associated sensor 65 about the x-axis, while another of the leveling actuation devices can be configured to selectively adjust the angular orientation, or tilt, of the associated sensor about the y-axis.

The peripheral system 68 can be configured to provide control functions, as well as other support functions, in facilitation of the operation of the leveling actuation device 65. For example, after the tiltmeter 100 is placed underground such as by burying or by lowering into a borehole, the peripheral system 68 can read the output of the sensor 64. The peripheral system 68 can then compare the output of the sensor 64 to a given value, wherein the given value corresponds to a substantially level orientation of the sensor.

If the peripheral system 68 determines that the output of the sensor 64 is significantly different from the given value, then the peripheral system can command the associated leveling actuation device 65 to adjust the angular orientation of the sensor so that the sensor output is no longer significantly different from the known value. In this manner, the sensor 64 can be substantially leveled, or “zeroed in.”

It is understood that the leveling or “zeroing in” procedure performed by the actuation device 65, and/or the peripheral system 68, can be substantially or fully automatic, wherein corrective adjustments to the orientation and/or position of the sensor 64 are performed without substantial human intervention. The automatic leveling procedure undertaken by the leveling actuation device 65 and/or the peripheral system 68 can be initiated upon receipt of an external command, or it can be performed at given time intervals, or the like.

A study of both FIGS. 1 and 4 reveals that the second element 20, along with all components supported thereby, such as the sensing apparatus 60 and the peripheral system 68, can be sealingly enclosed within the first element 10. With reference now to FIGS. 1 through 4, the tiltmeter 100 can be assembled for use by fastening the first end 21 of the second element 20 to the first end cap 121 by way of respective fasteners 3. That is, in accordance with one embodiment of the present disclosure, a method of assembling a tiltmeter such as the tiltmeter 100 is described herein.

The connector 125 can be installed in the first end cap 121 and can be communicatively linked, or connected, with the sensing apparatus 60. The second threaded member 32 can be fastened to the second end 22 of the second element 20 by way of respective fasteners 5. The sensing apparatus 60, as well as the peripheral system 68, can be fastened or otherwise secured to the second element 20.

This assembly can then be placed inside the first element 10 by first inserting the second end 22 of the second element 20 into the first end 11 of the first element 10. Insertion of the second element 20 into the first element 10 can continue until the first end cap 121, along with the first seal 41, is inserted into the first end 11 of the first element 10 so as to be in sealing engagement therewith.

The second end cap 122, along with the second seal 42, can be inserted into the second end 12 of the second element 20. The first threaded member 31, along with the third seal 43, can be at least partially inserted through the opening 4 defined by the second end cap 122. The first threaded member 31 can then be threadingly engaged with the second threaded member 32. The first threaded member 31 can be turned until a given level of substantially longitudinal stress is induced in the second element 20, as is described above.

In otherwords, a method of assembling a tiltmeter such as the tiltmeter 100 includes supporting the first end 21 of the second element 20 by the first end 11 of the first element 10, as well as supporting the second end 22 of the second element by the second end 12 of the first element. The method also includes supporting the sensing apparatus 60 on the second element 20. Moreover, the method can include inducing a substantially longitudinal stress in the second element 20, whereby a substantially equal and opposite substantially longitudinal stress is induced in the first element 10.

The given level of stress can be obtained, for example, by turning the first threaded member 31 for a predetermined number of revolutions after the first threaded member is initially “snugged up” against the second end cap 122. Alternatively, the given level of stress can be obtained, for example, by adjusting the first threaded member 31 to a predetermined level of torque. Such a predetermined level of torque can be measured, for example, by employing a torque wrench to turn the first threaded member. The given level of stress can be adjusted to obtain an increased degree of stability with regard to the second element 20.

Inasmuch as the stressing device 30 can include the first threaded member 31 and the second threaded member 32, the method can include disposing the stressing device between the first element 10 and the second element 20, wherein the stressing device is configured to induce the stress, as is explained above. In other words, the method of assembling a tiltmeter such as the tiltmeter 100 can include turning a threaded member, such as the first threaded member 31, wherein the threaded member is operatively disposed between the first element 10 and the second element 20.

The method of assembling a tiltmeter can continue with the connection of a data signal cable or other suitable communication link (not shown) with the connector 125. A hoist, or other suitable lifting means (not shown), can be attached to the hoist attachment 124. The tiltmeter 100 can then be lifted by a hoist, or by hand, into a substantially vertical orientation, wherein the first end 101 is substantially directly above the second end 102.

In this vertical orientation, the tiltmeter 100 can be placed underground. For example, the tiltmeter 100 can be lowered into a borehole, or otherwise buried in the earth. Once placed underground, data output from a given sensor 64 can be read by a human operator, or by the peripheral system 68 as described above. The output from the given sensor can be analyzed to determine if the sensor is significantly out-of-level. Such an out-of-level condition can occur if the borehole is not substantially vertical, or if the tiltmeter was not buried in a substantially vertical orientation.

An out-of-level condition of the sensor 64 can be detected and/or substantially corrected in the manner generally described above. For example, an operator, or the peripheral system 68, can compare the output of the sensor 64 to a known given value, wherein the given value is associated with a substantially level orientation of the sensor.

If it is found that the known given value is significantly different from the output of the sensor 64, then a determination can be made that the sensor in an out-of-level condition. In response, the associated leveling actuation device 65 can be operated to adjust the orientation of the sensor 64 so as to bring the sensor into a substantially level condition.

That is, the leveling actuation device 65 can be operated so as to adjust the orientation of the sensor 64 until the output of the sensor is substantially close to the known given value. Operation of the actuation device 65 can be controlled automatically by the peripheral device 68, or in the alternative, can be manually remotely controlled by an operator.

From its underground location, the tiltmeter 100 can detect small amounts of tilt or rotational movement and can generate data indicative of this detected tilt or movement. This data can be transmitted and/or recorded by the tiltmeter 100 for analysis.

The preceding description has been presented only to illustrate and describe exemplary methods and apparatus of the present disclosure. It is not intended to be exhaustive or to limit the disclosure to any precise form disclosed. Many modifications and variations are possible in light of the above teaching. It is intended that the scope of the invention be defined by the following claims.

What is claimed is:

1. A tiltmeter, comprising:
a first elongate element having first and second ends;
a second elongate element having a first end supported by the first end of the first element, and a second end supported by the second end of the first element; and
sensing apparatus supported by the second element.

2. The tiltmeter of claim 1, further comprising a stressing device operatively disposed between the first element and the second element, and configured to induce a given substantially longitudinal force in the second element, whereby a substantially equal and opposite substantially longitudinal force is induced in the first element.

3. The tiltmeter of claim 2, wherein the stressing device comprises a threaded member operatively disposed between the first element and the second element, wherein rotation of the threaded member causes inducement of the stresses.

4. The tiltmeter of claim 3, wherein:
the first element is substantially in the form of a tube; and
the second element is supported within the tube.

5. The tiltmeter of claim 4, further comprising:
a first end cap sealingly engaged with, and supported on, the first end of the first element, wherein the first end of the second element is supported by the first end cap; and
a second end cap sealingly engaged with, and supported on, the second end of the first element; wherein the second end of the second element is supported on the second end cap.

6. The tiltmeter of claim 5, wherein the threaded member is rotatably supported by the second end cap, and is threadingly engaged with the second end of the second element.

7. The tiltmeter of claim 6, wherein rotation of the threaded member induces tensile stress in the second element and compressive stress in the first element.

8. The tiltmeter of claim 2, wherein the stressing device is configured to induce tensile stress in the first element, and to induce compressive stress in the second element.

9. The tiltmeter of claim 2, wherein the stressing device is configured to induce compressive stress in the first element, and to induce tensile stress in the second element.

10. The tiltmeter of claim 2, wherein:
the first element is under tensile stress; and
the second element is under compressive stress.

11. The tiltmeter of claim 2, wherein:
the first element is under compressive stress; and
the second element is under tensile stress.

12. The tiltmeter of claim 1, the sensing apparatus comprising:
a tilt sensor; and
a leveling actuation device configured to selectively adjust the sensor orientation after placement of the tiltmeter underground.

13. A method of assembling a tiltmeter, comprising:
providing a first elongate element having a first and second ends;
supporting a first end of a second elongate element by the first end of the first element;
supporting a second end of the second element by the second end of the first element; and
supporting sensing apparatus by the second element.

14. The method of claim 13, further comprising inducing a substantially longitudinal force in the second element, whereby a substantially equal and opposite substantially longitudinal force is induced in the first element.

15. The method of claim 14, further comprising operatively disposing a stressing device between the first and second elements, wherein the stressing device is configured to induce the stresses.

16. The method of claim 14, further comprising turning a threaded member to induce the stresses, wherein the threaded member is operatively disposed between the first and second elements.

17. The method of claim 13, further comprising inducing a substantially longitudinal tensile force in the second element, whereby a substantially equal and opposite substantially longitudinal compressive force is induced in the first element.

18. The method of claim 13, further comprising inducing a substantially longitudinal compressive force in the second element, whereby a substantially equal and opposite substantially longitudinal tensile force is induced in the first element.

19. The method of claim 14, the sensing apparatus comprising a tilt sensor, the method further comprising:
placing the tiltmeter underground;
detecting an out-of-level condition in regard to the sensor in response to placing the tiltmeter underground; and
selectively adjusting the orientation of the sensor in response to detecting the out-of-level condition.

20. A tiltmeter, comprising:
an elongate element having first and second ends;
a means for supporting the element by the first and second ends; and
supported on the element, means for detecting tilt of the element.

21. The tiltmeter of claim 20, further comprising means for housing the element and the sensing apparatus, wherein the means for supporting the element comprises means for housing the element and sensing apparatus.

22. The tiltmeter of claim 20, further comprising means for inducing longitudinal stress in the element.

23. The tiltmeter of claim 20, further comprising means for selectively adjusting orientation of the means for detecting tilt after placement of the tiltmeter underground.
